(19) United States
(12) Patent Application Publication
(10) Pub. No.: US 2020/0180487 A1
(43) Pub. Date: Jun. 11, 2020

(54) Container holder for a vehicle or storage

(71) Applicant: Jessica Taylor Brown, Dallas, TX (US)

(72) Inventor: Jessica Taylor Brown, Dallas, TX (US)

(21) Appl. No.: 16/210,943

(22) Filed: Dec. 5, 2018

(51) Int. Cl. B60N 3/10; B60R 7/08; B65D 25/20

(52) U.S. Cl. CPC B60N 3/10; B65D 25/20; B60R 7/08

(57) ABSTRACT

A portable cone-shaped single container holder that is lightweight and holds sports beverage coolers, including half gallon sports beverage coolers, and other containers. The device can be placed on the flat floor, including the flat floor of a vehicle. Containers are placed in the open interior holding space or compartment. Even when free standing, the device's stable structure holds a container in the upright position. The container holder reduces spilling and damage to containers and their contents caused when bumped into or when the motion of the vehicle during reasonable driving conditions would otherwise cause the container to tip over. The container holder does not require additional balancing, weights, internal adjustments, or vehicle restraints. The container holder allows room for vehicle passengers feet, and allows for easy portability and travel.

### CROSS-REFERENCE TO RELATED APPLICATIONS

Provisional patent application filed Dec. 13, 2017, Application No. 62/598,163, Confirmation No. 2860, Inventor Jessica Taylor Brown, Dallas, Tex., and Applicant Jessica Taylor Brown, Dallas, Tex.

### STATEMENT REGARDING FEDERALLY SPONSORED RESEARCH OR DEVELOPMENT (IF APPLICABLE)

Not Applicable.

### REFERENCE TO SEQUENCE LISTING, A TABLE, OR A COMPUTER PROGRAM LISTING COMPACT DISC APPENDIX (IF APPLICABLE)

Not Applicable.

### FIELD OF THE INVENTION

The present invention relates to a container holding device used for storage or on the floor of a vehicle for transporting sport beverage coolers and other containers.

### BACKGROUND OF THE INVENTION

The purpose of the device is to securely hold sports beverage coolers, including half gallon sports beverage coolers, and other containers of various sizes when stored or placed in a vehicle to reduce spilling of liquids and damage to containers and their contents caused when force or the motion of the vehicle would otherwise cause them to tip over. I realized the need for this device as a “soccer mom” transporting my daughters and their sports beverage coolers to and from their sports practices and games and as a florist transporting flowers in various containers. I discovered quickly that if sports beverage coolers or flower containers were not secured by being properly held, they would quickly tip over in our car, spill liquids all over the floor, and in the case of flower containers break the vase or damage the flowers themselves.

### BRIEF SUMMARY OF THE INVENTION

The device is a portable cone-shaped container holder (the circular base is larger than the open compartment circular top) that is lightweight and holds sports beverage coolers, including half gallon sports beverage coolers, and other containers. The device can be placed on the flat floor, including the flat floor of a vehicle. Beverage coolers or other containers are placed in the open interior space or holding compartment of the device. Even when free standing (untethered to any other structure or any part of the vehicle), the device holds a beverage cooler or container in the upright position. By doing so, the device reduces spilling of liquids and damage to containers and their contents caused when bumped into or when the motion of the vehicle during reasonable driving conditions would otherwise cause the beverage coolers or containers to tip over. The advantages of the device include its efficacy at reducing spilling and tipping over of beverage coolers and containers, its streamlined design that uses little space and allows for ample foot room for vehicle passengers, and the device structure's use of gravity instead of tethering to hold the device and its contents upright and in place, all while being affordable, convenient to use, lightweight, portable, and easy to manufacture, ship, store and display.

### BRIEF DESCRIPTION OF THE SEVERAL VIEWS OF THE DRAWING

FIG. 1—Depicts and diagrams the interior and exterior dimensions and angles of the portable cone-shaped container holder device. This depiction (and therefore the dimensions) is sized to hold half gallon sports beverage coolers and similar dimensioned containers. The exterior is 5 inches tall with walls sloped at approximately 72.25 degrees from the 6.69-inch diameter top to the 10.13-inch diameter base that rests on the ground. The circular opening at the top is 6.44 inches in diameter with walls that are sloped at approximately 79.25 degrees for 3.44 inches down from the top to allow the device to be stacked. Then the slope straightens to 90 degrees for 1.94 inches until it meets the 5.75-inch diameter bottom of the interior of the inner compartment to accommodate and secure the right-angle base of a cooler or container. The 6-inch diameter exterior base of this inner container also rests on the ground.

FIG. 2—Depicts in three dimensions from a side, elevated translucent view the interior walls, interior container compartment, exterior walls, and the base of the cone-shaped container holder device.

FIG. 3—Depicts a front exterior view of the cone-shaped container holder device:

FIG. 4—Depicts an elevated front exterior and interior wall view of the cone-shaped container holder device.

FIG. 5—Depicts a top view of the exterior wall and interior compartment of the cone-shaped container holder device.

FIG. 6—Depicts an angled bottom view of the base of the internal compartment and exterior wall of the cone-shaped container holder device.

FIG. 7—Depicts a bottom view of the base of the internal compartment and external base of the cone-shaped container holder device.

FIG. 8—Depicts a directly top view of the cone-shaped container holder device.

FIG. 9—Depicts a directly bottom view of the cone-shaped container holder device.

FIG. 10—Depicts a picture of the ability to stack the cone-shaped container holder device.

### DETAILED DESCRIPTION OF THE INVENTION

The example embodiments of the portable cone-shaped container holder device will be more clearly understood from the following description taken in conjunction with the accompanying drawings. The accompanying drawings represent non-limiting, example embodiments as described herein.

The device is a portable cone-shaped single item container holder with an open top that is smaller in diameter than its base. The device is convenient, lightweight, portable, and holds sports beverage coolers, including half gallon sports beverage coolers, and other containers.

The device can be placed on and rests securely on a level floor, including the level rubber or carpeted floor inside a vehicle. Beverage coolers or other containers are placed in the open interior space or holding compartment of the device. The device has an inner section deep and angled to hold beverage coolers and other containers in place securely with a wider exterior section that flares out at the base to add stability. Even when free standing (untethered to any other structure or any part of a vehicle), the device holds a beverage cooler or container in the upright position. When a beverage cooler or other container is placed into the inner compartment of the device, the added weight of the container being held increases the center of gravity of the device to further reduce tipping that could otherwise occur due to external forces including direct impact forces as well as motion forces (rotation, changes in elevation, acceleration, or deceleration) applied when in a moving vehicle under reasonable driving conditions. The device reduces spilling of liquids and damage to containers and their contents caused when bumped into or when the motion of the vehicle during reasonable driving conditions would otherwise cause the beverage cooler or container to tip over.

The advantages of the portable cone-shaped container holder device include its efficacy at reducing spilling and tipping over of beverage coolers and containers, its streamlined design that is small enough (even when sized to hold half gallon sports beverage coolers) to allow for ample foot room for vehicle passengers, and the added convenience created by the device structure that allows gravity instead of tethering to hold the device and its contents upright, all while being affordable, convenient to use, lightweight, portable, and easy to manufacture, ship, store and display.

The device is a portable device that can be moved from vehicle to vehicle and can be carried in a sports bag. The device can be easily stacked in boxes for shipping, in store displays, and at home for easy storage. The lightweight, one-piece plastic design reduces manufacturing, retail and shipping costs and increases ease of use and portability.

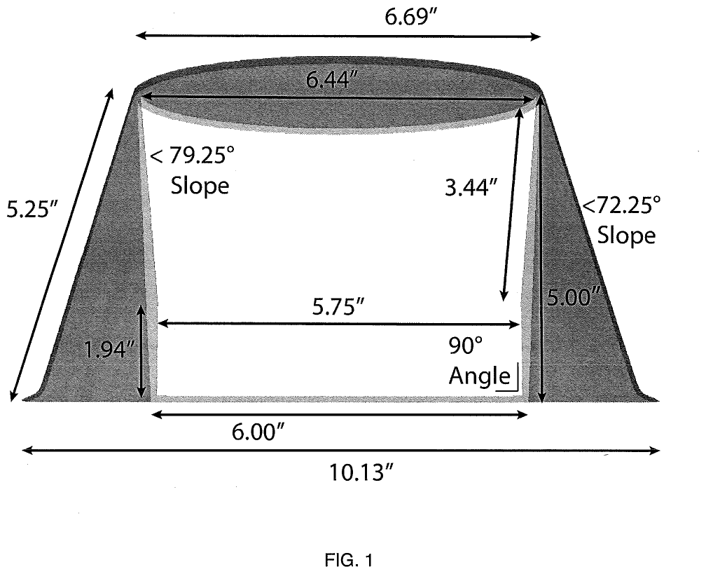

The device's manufacturing dimensions can be increased or decreased proportionally as part of the manufacture process to accommodate different size sports beverage coolers and other containers and objects while retaining the intended utility. The opening at the top of the container holder as depicted in FIG. 1 is large enough to accommodate several types of halt gallon sports beverage coolers and other containers similar in size. Although the structure of the device as described in FIG. 1 is ideal, the interior slope angles can be adjusted, if desired, to increase or decrease the top opening diameter and increasing or decreasing the exterior slope angle without fully compromising efficacy while maintaining a wider diameter base.

The cone-shaped potable container holder device creates unique stability through both its cone-shaped exterior that flares out at the base plus its interior weight bearing container design that increases the device's center of gravity inside its base. The bottoms of both the interior container and flared exterior touch and distribute weight to the ground thereby further increasing stability.

The process of designing and making the device evolved from drawings to the initial concept being modeled from a polygon in Autodesk Maya 2016. Once the concept was modeled into a 3D design it was saved as a .mb file. In order to print the 3D design it was exported in Maya as an .stl file and then converted to a .gcode file using Ultimaker Cura 3D slicer software. The original developmental files were taken to a local Dallas 3D print shop (after the execution of a non-disclosure agreement) where they were printed into several plastic prototypes. Device testing and development was then conducted to determine optimum utility characteristics. After the initial device prototype development and testing, additional modifications and prototype productions occurred to further test and enhance efficacy, reduce likely manufacturing costs, increase storage and convenience, and reduce needed display space. The prototype production included testing different interior and exterior wall angles, product materials (including hard plastics versus silicone), one or two-piece construction, and various structural attributes (including solid, flexible, or folding, or a combination of solid and folding) to balance efficacy, weight, manufacture cost, shipping cost, storage and convenience, and display variables.

After additional prototype development and testing, it was determined that the device should be a cone-shaped device that is portable, lightweight, plastic, and stackable. An embodiment of the portable cone-shaped device including interior container, and exterior wall angles is detailed in FIG. 1.

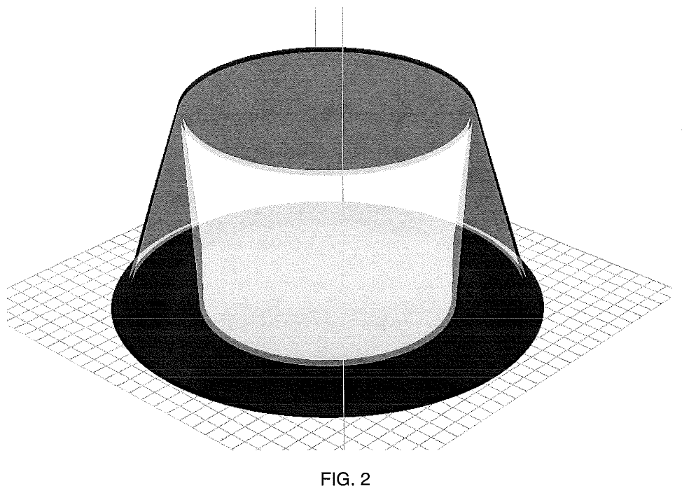

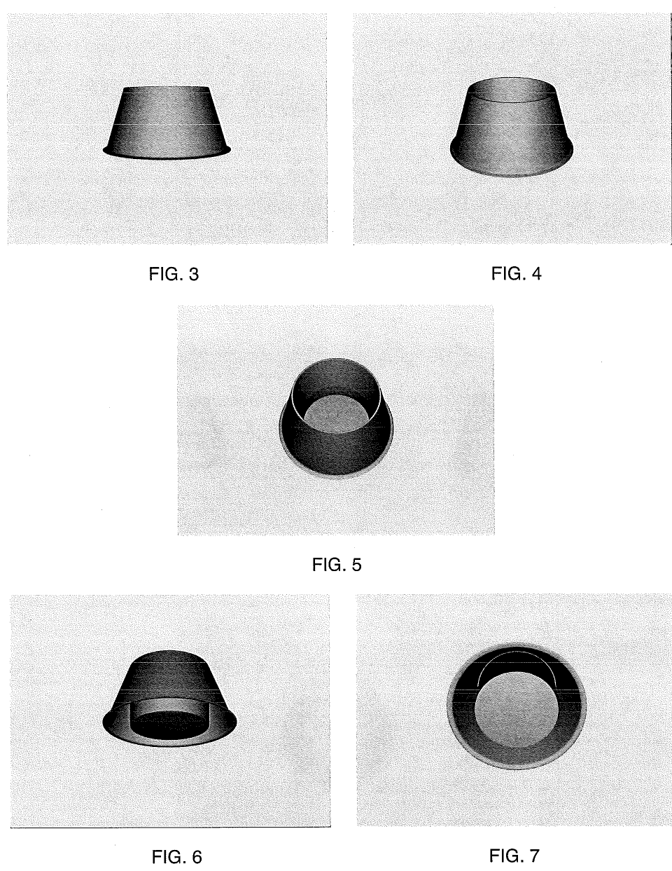

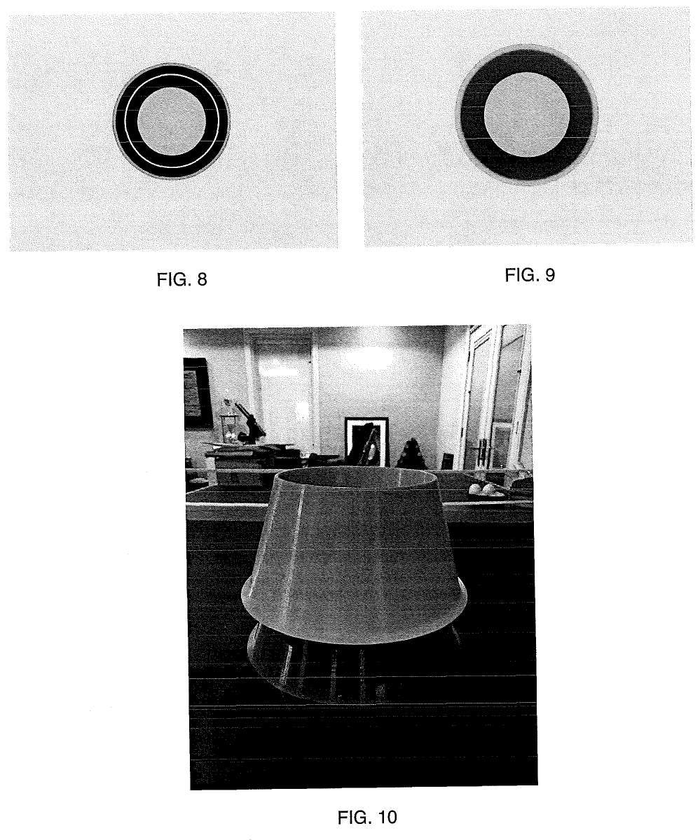

FIG. 2 demonstrates in three dimensions a translucent view the interior walls, container compartment, exterior walls, and the base of the portable cone-shaped device. FIG. 3 depicts a front exterior view. FIG. 4 depicts an elevated front exterior and interior wall view. FIG. 5 depicts a top view of the exterior wall and interior compartment. FIG. 6 depicts an angled bottom view of the base of the interior compartment and exterior wall. FIG. 7 depicts a bottom view of the base of the internal compartment and external base. FIG. 8 depicts a direct top view. FIG. 9 depicts a direct bottom view. FIG. 10 demonstrates how the cone-shaped device is easily stackable for shipping, display, and storage.

The embodiment of the device detailed in FIG. 1 is sized to hold various half gallon sport beverage coolers and similar dimensioned containers. It is 5 inches tall and has walls sloped at approximately 72.25 degrees from the 6.69-inch diameter top to the 10.13-inch diameter base. The base of the flared exterior wall rests on the ground. The circular opening at the top is 6.44 inches in diameter with walls that are sloped at approximately 79.25 degrees for 3.44 inches from the top to allow the device to be stacked. Then the slope straightens to 90 degrees for 1.94 inches until it meets the 5.75-inch diameter bottom of the interior of the inner section to accommodate and secure the right-angle base of the cooler or container placed inside. The 6-inch diameter exterior base of this inner container also rests the ground. The device uses the added weight of the sports beverage cooler itself (or other item or container being held) to increase the center of gravity of the device to further reduce tipping that could otherwise occur due to external forces including direct impact forces as well as motion forces (rotation, elevation, acceleration, deceleration) applied in a moving vehicle.

The final prototype of the device shown stacked in FIG. 10 was printed using a Creality Cr10 3D printer with PLA filament. Further device testing was then done. Such testing confirmed the efficacy of the device. The device was also downsized with the same angle proportions shown in FIG. 1 and printed to test its ability to accommodate a smaller (in this case 1-quart size) beverage cooler. This proportionally reduced device testing also successfully demonstrated that the size of the device can be proportionally adjusted to both downsize the device for smaller beverage coolers or containers or upsize the device to accommodate larger coolers or containers.

The mass manufacture of the device will occur using plastic injection molding, injecting molten plastic into steel or aluminum single cavity or multi-cavity moulds.

The device is a new invention solving an old problem. Unlike square or rectangular boxes, chests, tubs, or buckets, the portable cone-shaped container holder device's flared cone-shaped exterior and weight bearing, center of gravity open interior compartment is specially suited to easily place, hold upright, and then remove a single sports beverage cooler or similar dimensioned container while simultaneously being structured to remain stable to reduce the spilling of liquids and damage to containers and their contents from tipping over even when free standing in a moving vehicle during reasonable driving conditions. The structure of the device creates stability (a) without the need to balance the container holder with a matching beverage cooler or container, (b) without the need or use of additional weights, internal compartment adjustments, or packing fill materials, and (c) without the need or use of additional vehicle restraints or tethering, while simultaneously minimizing the use of space to allow room for vehicle passengers feet. Moreover, unlike square or rectangular boxes, chests, tubs, or buckets, the device's small size and lightweight allow it to fit into a sports bag for easy portability and travel.

1. A container holder device comprising: a portable cone-shaped container holder, said portable cone-shaped container holder having an open top that is smaller in diameter than its base; said portable cone-shaped container holder having an open interior compartment to receive a container; and said portable cone-shaped container holder providing access to remove a container placed in the device's interior compartment.

2. A container holder device of claim 1 wherein it is structured to be free-standing on and removable from a flat planar surface.

3. A container holder device of claim 1 wherein the device's interior top edge is structured to retain a container in the upright position.

4. A container holder device of claim 1 wherein the device has an inner container holding compartment.

5. A container holder device of claim 1 wherein the device's interior compartment walls are structured to retain a container in the upright position.

6. A container holder device of claim 1 wherein the wider exterior section flares out at the base.

7. A container holder device of claim 1 wherein the device is structured to be stable and remain upright when a container is placed into the inner compartment of the device.

8. A container holder device of claim 1 wherein the center-of-gravity weight bearing and dispersing device structure produces stability that allows the device and the container placed into the inner compartment of the device to remain in the upright position.

9. A container holder device of claim 1 wherein the device is structured to be lightweight and portable.

10. A container holder device of claim 1 wherein the device when in use or not in use can be placed on the passenger vehicle floor allowing ample passenger foot room.

11. A container holder device of claim 1 wherein the device's structure can be downsized or upsized to accommodate various sizes of containers.

12. A container holder device of claim 1 wherein the device's structure allows for easy placement, storage, and removal of a container from the device.

13. A container holder device of claim 1 wherein the device's structure allows the device and the container placed into the inner space of the device to remain upright on carpeted vehicle floors or on rubber vehicle floor mats.

14. A container holder device of claim 1 wherein the device is structured to store easily in a vehicle or on a shelf when not in use.

15. A container holder device of claim 1 wherein the device is easy to ship because it is structured to be lightweight and stackable.
